(19) United States
(12) Patent Application Publication
(10) Pub. No.: US 2016/0114715 A1
(43) Pub. Date: Apr. 28, 2016

(54) SEAL ASSEMBLY FOR RECREATIONAL VEHICLE HAVING SLIDE-OUT ROOM

(71) Applicant: LIPPERT COMPONENTS, INC., Elkhart, IN (US)

(72) Inventor: Norman L. NEWHOUSE, Mishawaka, IN (US)

(21) Appl. No.: 14/921,663

(22) Filed: Oct. 23, 2015

Related U.S. Application Data
(60) Provisional application No. 62/068,311, filed on Oct. 24, 2014.

(51) Int. Cl. B60P 3/36; B60R 13/06; F16J 15/06; F16J 15/10; F16J 15/02

(52) U.S. Cl. CPC B60P 3/36; F16J 15/104; F16J 15/022; F16J 15/061; B60R 13/06

(57) ABSTRACT

A seal assembly includes a mounting portion and a seal portion that may be attached to and removed from the mounting portion. The seal portion may have a tab and the mounting portion may have a tab-receiving channel configured to receive the tab. The mounting portion may include an expansion joint. The seal portion may include a bulb seal having a complex profile and a wiper extending from an exterior portion thereof.

### CROSS REFERENCE TO RELATED APPLICATION

This application claims benefit of U.S. Provisional Patent Application No. 62/068,311, filed on Oct. 24, 2014, and incorporates by reference the disclosure thereof in its entirety.

### BACKGROUND OF THE DISCLOSURE

This disclosure relates generally to seals and, more particularly, to seal assemblies that could be used to seal an interface between a side wall of a structure and a slide-out compartment that can extend and retract through an opening in the side wall. The structure could be a recreational vehicle (RV) and the slide-out compartment could be a slide-out room or another slide-out compartment of the RV.

Bulb seals having generally D-shaped cross-sections have been used to seal such interfaces. Such bulb seals may include a planar base portion that may be attached to one of the surfaces of the interface to be sealed, and a bulb portion connected to the base portion. The bulb portion may be selectively engaged with the other of the surfaces to be sealed.

### SUMMARY OF THE DISCLOSURE

The disclosure shows and describes illustrative embodiments of a seal assembly including a U-shaped base portion and a bulb seal portion. The base portion may include a web, a pair of flanges extending from a first side of the web, and a tab-receiving channel extending from at least one of said flanges. The mounting portion may include a wiper extending from a second, opposing side of the web. The web may include an expansion joint. The expansion joint may include a region of reduced thickness.

The bulb seal portion may include a bulb and a tab. The bulb may have a cross-section including a generally circular portion and two generally linear portions. The tab may be insertable into and removable from the tab-receiving channel when the tab and the tab-receiving channel are in a first relative orientation, and the tab may be fixedly secured within the tab-receiving channel when the tab and the tab-receiving channel are in a second relative orientation. The first and second relative orientations may be achieved by rotating the tab with respect to the tab-receiving channel. The bulb seal portion may include a wiper extending from the bulb. The wiper may extend tangentially from the bulb.

The mounting portion and bulb seal portion may include corresponding latching elements configured for selective engagement with each other.

### BRIEF DESCRIPTION OF THE DRAWINGS

FIG. 1 is an end view of an illustrative seal assembly including a mounting portion attached to a sidewall of a structure and a separate bulb seal portion configured for attachment to the mounting portion;

FIG. 2 is an end view of the seal assembly of FIG. 1 with the bulb seal portion engaged with and secured to the mounting portion;

FIG. 3 is an end view of the seal assembly of FIG. 1 further including an expansion joint in the mounting portion thereof;

FIG. 4 is an end view of another illustrative seal assembly including a mounting portion attached to a sidewall of a structure and a separate bulb seal portion configured for attachment to the mounting portion;

FIG. 5 is an end view of the illustrative seal assembly of FIG. 4 with the bulb seal portion engaged with but not secured to the mounting portion;

FIG. 6 is an end view of the illustrative seal assembly of FIG. 4 with the bulb seal portion engaged with and secured to the mounting portion;

FIG. 7 is an end view of an illustrative seal assembly attached to a header portion of an aperture in a wall of a recreational vehicle with wiper seals engaged with a roof of a slide-out room being extended through the aperture from an interior of the recreational vehicle;

FIG. 8 is an end view of the illustrative seal assembly of FIG. 7 attached to a header portion of an aperture in a wall of a recreational vehicle with wiper seals engaged with a roof of a slide-out room being retracted through the aperture into the interior of the recreational vehicle;

FIG. 9 is a detail view of a bulb seal portion of an illustrative seal assembly;

FIG. 10 is a side elevation view of bulb seal portion of an illustrative bulb in various stages of compression between a flange of a slide out compartment and a side wall of a structure; and

FIG. 11 is a detail view of a portion of an illustrative bulb of a bulb seal according to the present disclosure.

### DETAILED DESCRIPTION OF THE DRAWINGS

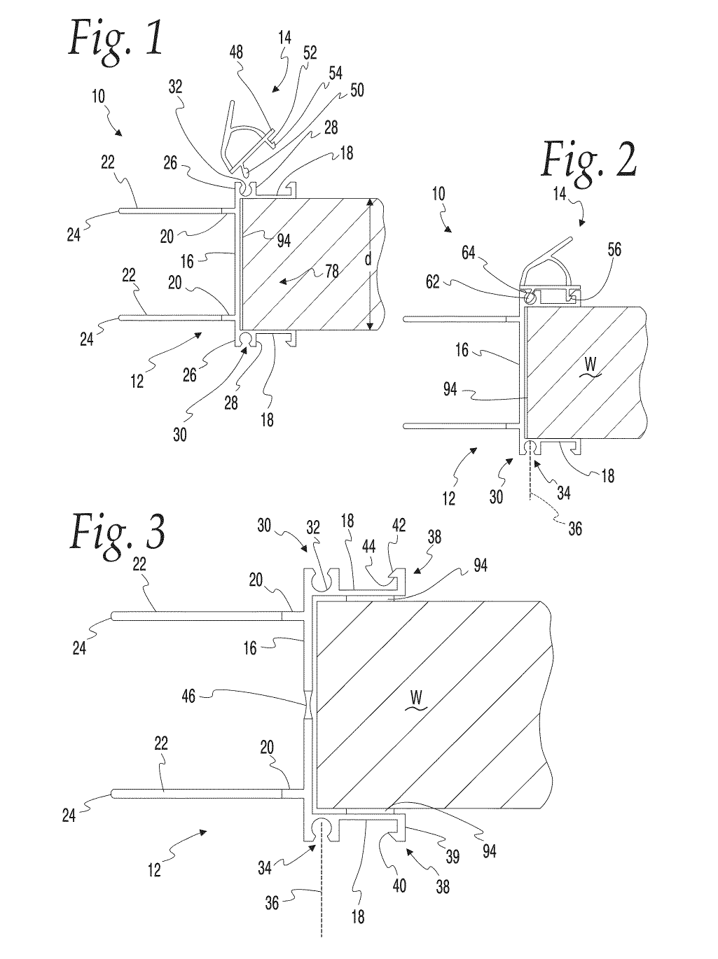

FIGS. 1-3 show embodiments of an illustrative seal assembly 10. The seal assembly 10 includes a mounting portion 12 configured for attachment to a side wall W of a structure, for example, an exposed edge of a side wall of a structure circumscribing an opening in the side wall of the structure. The structure could be an RV and the opening could be an opening through which a slide-out compartment can be extended and retracted. The slide-out compartment could be a slide-out room or another form of slide-out compartment, for example, a storage compartment or drawer. The seal assembly also includes a bulb seal portion 14 configured for attachment to the mounting portion 12. The mounting portion 12 and the bulb seal portion 14 may be elongated. For example, as shown in the drawings, the mounting portion 12 and the bulb seal portion 14 may extend indefinitely into the page, or they may have any shorter length.

The mounting portion 12 is shown as a generally U-shaped channel having a web 16 and a pair of flanges 18 extending from one side of the web proximate the ends thereof and generally perpendicular thereto. The web 16 and flanges 18 cooperate to define an interior region 78 configured to receive or straddle wall W. A pair of wiper supports 20 extends from the other side of the web 16, generally perpendicular thereto. A wiper 22 extends from each of the wiper supports 20. Other embodiments could include more or fewer wiper supports 20 and wipers 22. Each of the wipers 22 terminates in a free end 24. The wipers 22 are sufficiently flexible and resilient as to be deflected elastically in response to a force applied thereto.

First and second opposing walls 26, 28 extend outwardly (with respect to the interior region 78) from at least one of the flanges 18 (in the embodiments shown in FIGS. 1-3, first and second opposing walls 26, 28 extend from each of the flanges 18). The first and second walls 26, 28 and corresponding portion of flange 18 cooperate to define an outwardly-facing, tab-receiving channel 30 having an arcuate inner wall 32. The first and second walls 26, 28 further cooperate to define a channel opening 34 proximate the free ends thereof. The opening has a centerline 36 that is generally perpendicular to the flange 18. The free ends of the first and second walls 26, 28 are beveled to facilitate insertion of a tab thereinto, as will be discussed further below.

A mounting portion latch 38 is provided with at least one of the flanges 18 (in the embodiments shown in FIGS. 1-3, a mounting portion latch 38 is provided with each of the flanges 18). The mounting portion latch 38 includes a stand-off 39 extending outwardly from the flange 20. A catch 40 is provided at the end of the stand-off 39 opposite the flange 18 from which it extends. The catch 40 includes an outwardly-facing ramped surface (or ramp) 42 and an inwardly-facing catch surface 44. The catch surface 44 is generally parallel to the corresponding flange 18.

The distance d between inner surfaces of the flanges 18 may be selected so that the mounting portion 12 may be closely fitted over the side wall W. In order to accommodate variations in thickness of the side wall W, the web 16 could include an expansion joint 46 located between the flanges 18, as shown in FIG. 3 (FIGS. 1 and 2 show the web 16 without an expansion joint). When provided, the expansion joint 46 could be embodied as a region of reduced thickness having an hour-glass shape, as shown, or another shape. The expansion joint 46 could comprise an elastomeric material allowing an extension of the length of the web 16 by about 3/16″, or more or less, by pulling the portions of the web 16 on opposite sides of the expansion joint 46 apart (that is, in opposite directions). The expansion joint 46 could be embodied in other ways, as well.

The mounting portion 12 could be integrally formed in one piece using, for example, an extrusion process. The mounting portion could be formed of, for example, plastic, rubber, an elastomer, or another suitable material. The wiper(s) 22 and the expansion joint 46 may be made of a different material than the rest of the mounting portion. In such an embodiment, the wiper(s) 22 and the expansion joint 46 of different materials may be co-extruded with the rest of the mounting portion 12.

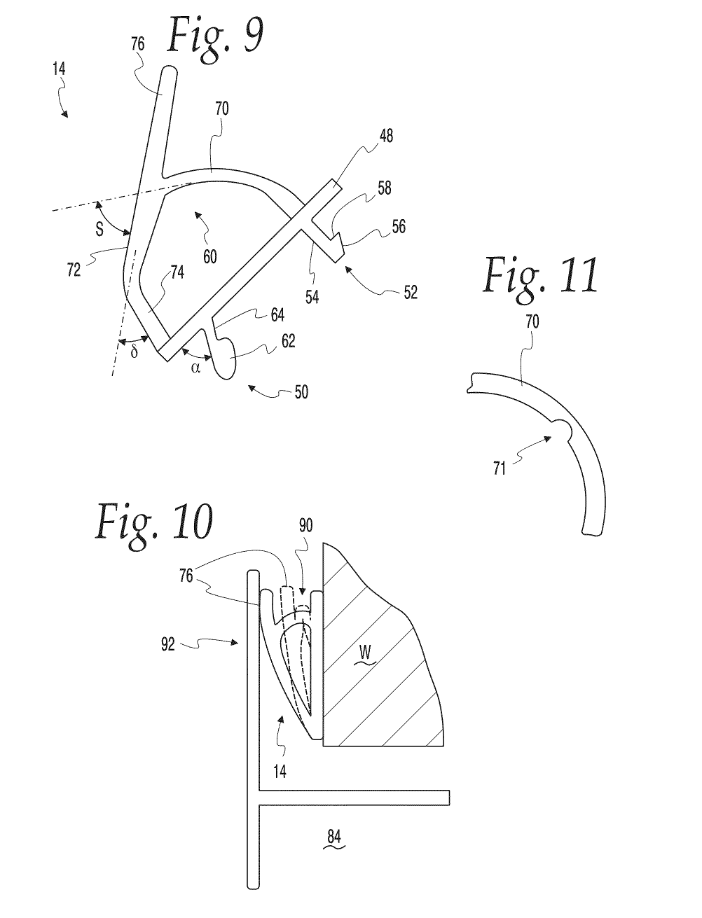

As best shown in FIG. 9, the bulb seal portion 14 includes a generally planar base 48, a tab 50 extending from a first side of the base 48 and proximate a first end thereof, a seal portion latch 52 extending from the first side of the base 46 and proximate a second end thereof, and a bulb 60 extending from a second side of the base 48 proximate the first and second ends thereof. A wiper 76 extends generally tangentially from the bulb 60.

The tab 50 includes a generally egg shaped cam 62 and a stem 64 connecting the cam to the base 48. The stem 64 is shown as extending from the base 48 at an angle a of about 60° with respect to the base 48. In other embodiments, the angle α could have other values, greater or less than 60°, for example, between 45° and 75° or more or less.

The seal portion latch 52 is configured in a manner complementary to the mounting portion latch element 40. That is, the seal portion latch 52 includes a stand-off 53 and a catch 54. The catch 54 includes a ramped surface 56 facing generally away from the base 48 and a catch surface 58 facing and generally parallel to the base 48.

The bulb 60 has a complex cross-sectional profile including an arcuate portion 70 (which is shown as generally quarter-circular) having a first end extending from a first side of the base 48, a first generally linear portion 72 having a first end extending from a second end of the quarter-circular portion 70 at a secant angle S thereto, and a second generally linear portion 74 having a first end extending from the second end of the first linear portion 72 at an angle δ thereto and a second end extending from the base 48. As such, the profile of bulb 60, in its normal, uncompressed, relaxed state, appears as a partially flattened semi-circle. The wiper 76 extends outwardly from the bulb 60 generally collinear and coextensive with the first linear portion 72 of the bulb. The arcuate portion 70 of the bulb 60 may be of non-uniform thickness. For example, the arcuate portion 70 of the bulb 60 may be relatively thick proximate its first and second ends and relatively thin in an intermediate region between its first and second ends. In an embodiment, as shown in FIG. 11, the arcuate portion 70 of the bulb 60 may have a substantially uniform thickness except for a region proximate a scallop 71 formed into an inner surface of the arcuate portion intermediate its first and second ends. The scallop 71 or other region of reduced thickness of the arcuate portion 70 intermediate its first and second ends may facilitate flattening of the bulb 60 when compressed between two surfaces, as will be discussed further below.

The seal assembly 10 may be installed to a structure by slipping the mounting portion 12 over an exposed edge of a side wall W thereof. In the event that the thickness of the side wall W is greater than the dimension d between the flanges 18 of the mounting portion 12, and if the mounting portion 12 includes the optional expansion joint 46, the installer can pull the ends of the web 16 away from each other to increase the distance d between the flanges 18 to a distance that may be sufficient to fit the mounting portion 12 over the edge of the side wall W. The mounting portion 12 may be secured to the wall using an adhesive, for example, an adhesive strip 94, between the side wall W and the interior region 78 of the channel defined by the web 16 and the flanges 18. Alternatively or additionally, mechanical fasteners, for example, screws, may be run through the web 16 and/or either or both flanges 18 into the side wall W.

As best shown in FIGS. 1 and 2, the bulb seal portion 14 may be attached to the mounting portion 12 by inserting the tab 50 into the tab-receiving channel 30. Based on the relative shapes of the tab 50 and the tab-receiving channel 30, the base 48 of the bulb seal portion 14 typically would be at or about some angle with respect to the corresponding flange 18 of the mounting portion 12 and the seal portion latch 52 would be distant from the mounting portion latch 38. Once the tab 50 has been inserted into the tab-receiving channel 50, the bulb seal portion 14 may be rotated through an arc such that the ramped surface 56 of the seal portion latch 52 engages with the ramp surface 42 of the mounting portion latch 38. The bulb seal portion 14 may then be further rotated with respect to the mounting portion 12 such that the ramps 42, 56 override each other and the catch surface 44 of the mounting portion 12 engages with the catch surface 58 of the seal portion 14.

In this condition, base 48 of the bulb seal portion 14 may, but need not, be generally parallel to the corresponding flange 18 of the mounting portion 12. Also, in this condition, cam 62 is oriented such that tab 50 cannot be readily removed from channel 30.

The seal portion 14 could be removed from the mounting portion 12 by directly or indirectly applying pressure to the base 48 of the seal portion 14 in a manner that allows the catch surface 58 of the seal portion 14 to become disengaged with the catch surface 44 of the mounting portion 12 and then rotating the seal portion 14 in the opposite direction as described above to a positon where the tab 50 can be removed from the tab-receiving channel 30.

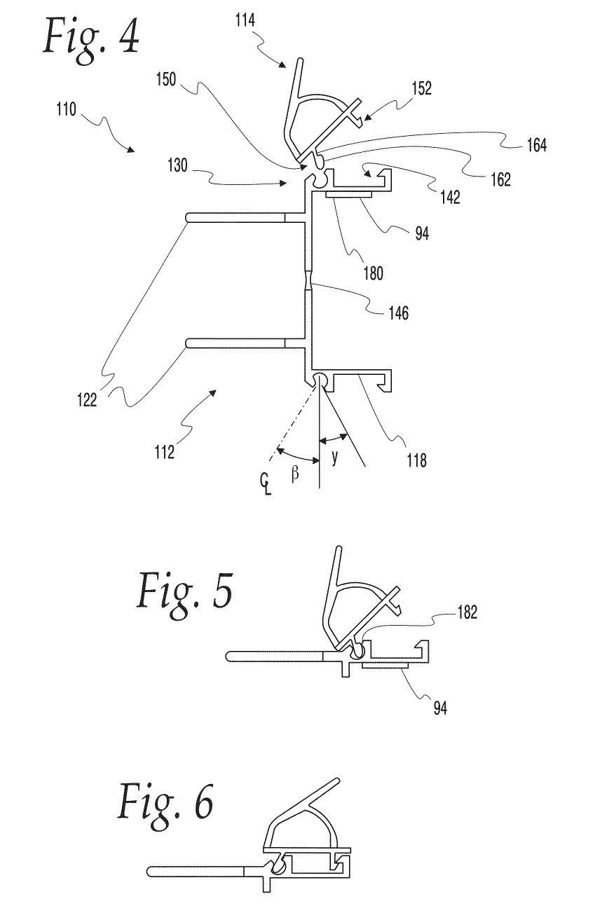

FIGS. 4-6 show another illustrative seal assembly 110. Seal assembly 110 is identical to seal assembly 10 in most respects. Components of seal assembly 110 corresponding to like components of seal assembly 10 may be identified by like reference numerals incremented by 100. Seal assembly 110 differs from seal assembly 10 with respect to the configuration the tab-receiving channel 130. Whereas the inner wall 32 of the tab-receiving channel 30 is generally arcuate, the inner wall 132 of the tab-receiving channel 130 includes an arcuate portion 129 and an interfering portion 131. The interfering portion 131 is shown as generally linear and defining a chord between an end of the arcuate portion 129 and the channel opening 134. The arcuate portion 129 has a first end terminating at the opening 130 and a second end terminating at the interfering portion 131. The interfering portion 131 has a first end terminating at the second end of the arcuate portion 129 and a second end terminating at the opening 130. A centerline C_{L} of the opening is at an angle β of about 27.5°, or a greater or lesser angle, with respect to the flange 120. A bearing surface 180 extends from the first end of the arcuate portion 129 outwardly at an angle y with respect to the flange 118. The angle γ as shown is about 45° but could be a greater or lesser angle.

The tab-receiving channel 130 is configured to receive and engage with the tab 150 of the bulb seal portion 114 in a manner similar to that described above in connection with the seal assembly 10. The configuration of the tab-receiving channel 130, however, precludes sliding of the bulb seal portion 114 with respect to the mounting portion 112 when attached thereto. More specifically, as best shown in FIGS. 5 and 6, when the seal portion 114 is rotated into latched engagement with the mounting portion 112, the cam 162 engages with and imparts pressure against the bearing surface 180. Also, the stem 164 engages with and imparts pressure against the beveled surface 182 adjacent the channel opening 134. The foregoing engagement of the tab 150 with the tab-receiving channel 130 alone or in combination with the properties of the materials from which these elements are made precludes sliding of the seal portion 114 with respect to the mounting portion 112 once fully attached thereto, that is, once the tab 150 has been inserted into the tab-receiving channel 130 and the seal portion latch 152 has become engaged with the mounting portion latch 138.

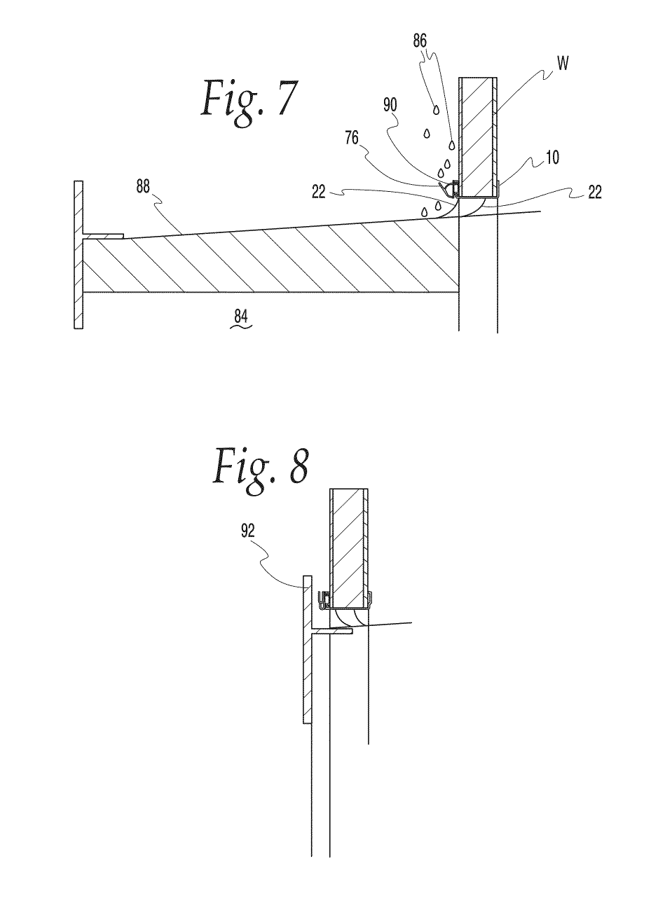

FIGS. 7 and 8 illustrate the seal assembly 10 attached to a side wall W of a recreational vehicle equipped with a slide-out room 84 (the seal assembly 110 could be installed to the side wall W in a like manner). More specifically, FIG. 7 shows a side wall W having an aperture therein. The aperture has a top edge, a bottom edge, a left edge and a right edge. The seal assembly 10 is shown as being attached to the side wall W adjacent the top edge of the aperture. The seal assembly 10 also could be attached to the side wall W adjacent the side and/or bottom edges of the aperture.

FIG. 7 illustrates the slide-out room 84 being extended from the recreational vehicle or in the extended state after having been extended from the recreational vehicle. The wipers 22 are shown in contact with a roof 88 of the slide out room 84 and deflected outwardly from their positions as shown in FIGS. 1-6. The bulb 60 is shown in its normal, uncompressed, relaxed state. The wiper 76 is shown as cooperating with the bulb 60 to form a trough or gutter 90. The gutter 90 is shown as collecting water droplets 86 and channeling them to the ends of the gutter 90, away from the roof 88 of the slide-out room 84. The gutter 90 may further receive and channel water sheeting down the exterior surface of the side wall W.

FIG. 8 illustrates the slide-out room 84 being retracted into the recreational vehicle or in a partially retracted state. The wipers 22 are shown in contact with the roof 88 of the slide out room 84 and deflected inwardly from their positions as shown in FIGS. 1-6. The wipers 22 function to wipe water, debris, and the like from the roof 88 as the slide-out room 84 is retracted.

When the slide-out room 84 is fully retracted, an exterior flange 92 attached to the slide-out room 84 engages with and compresses the bulb 60. The configuration of the bulb 60 allows for substantial contact surface area between the exterior flange 92 and the bulb 60. FIG. 10 illustrates the seal in a partially compressed state (solid lines) and a fully compressed state (dashed lines).

In other embodiments, the bulb could have a conventional D-shaped profile or any other suitable profile. Such embodiments could, but need not, include a wiper similar to wiper 62 extending tangentially or otherwise from an outer portion of the bulb. Also, in such embodiments, the bulb could have a region of reduced thickness to facilitate flattening thereof when compressed between two surfaces.

The mounting portion 12 and the bulb seal portion 14 could be configured to provide sufficient clearance between the flange 18 of the mounting portion and the base 48 of the bulb seal portion such that a wiring harness could be disposed there between.

Features of any embodiment described herein could be combined with features of any other embodiment described herein to the extent possible. The foregoing embodiments are illustrative and may be modified without departure from the scope of the appended claims.

1. A seal assembly comprising:
a mounting portion comprising:
a generally planar web having a first portion, a second portion, and an expansion joint connected between said first portion and said second portion;
a first flange extending in a first direction from said first portion of said web;
a second flange extending in said first direction from said second portion of said web, said web, said first flange, and said second flange cooperating to define an interior region;
a mounting portion wiper extending in a second direction from one of said first portion of said web and said second portion of said web, said second direction opposite said first direction;
a first tab-receiving channel extending in a third direction from said first flange, said third direction generally perpendicular to said first direction and outward from said interior region; and
a first mounting portion latch extending in said third direction from said first flange; and
a seal portion selectively attachable to said mounting portion, said first seal portion comprising:
a base having a first side and a second side;
a tab extending from said first side of said base, said tab configured for selective engagement with said first tab-receiving channel;
a seal portion latch extending from said first side of said base;
a bulb extending from said second side of said base, said bulb comprising a sidewall having an arcuate portion connected to a first portion of said base, a first planar portion connected to said arcuate portion, and a second planar portion connected to a second portion of said base and to said first planar portion, and a seal portion wiper extending from said first planar portion.

2. The seal assembly of claim 1 wherein said tab and said tab-receiving channel are configured to facilitate insertion of said tab into and removal of said tab from said tab-receiving channel when said tab is in a first orientation with respect to said tab-receiving channel and to resist removal of said tab from said tab-receiving channel when said tab is in a second orientation with respect to said tab-receiving channel.

3. The seal assembly of claim 2 wherein said seal portion latch is configured to engage with said mounting portion latch when said tab is moved from said first orientation to said second orientation by rotation of said seal portion with respect to said mounting portion.

4. The seal assembly of claim 2 wherein said tab and said tab-receiving channel are configured to resist sliding of said tab within said tab-receiving channel when said tab is in said second orientation.

5. The seal assembly of claim 1 wherein said arcuate portion of said bulb has a first end connected to said base, a second end connected to said first planar portion, and wherein said sidewall of said arcuate portion has a region of reduced sidewall thickness intermediate said first end and said second end.

6. The seal assembly of claim 5 wherein said region of recued thickness comprises a scallop extending inwardly into said sidewall an inner surface of said sidewall.

7. The seal assembly of claim 1 wherein said seal portion wiper cooperates with said arcuate portion to define a gutter.

8. A seal assembly comprising:
a mounting portion comprising:
a mounting portion base;
a tab-receiving channel extending in a first direction from said mounting portion base; and
a mounting portion latch extending in said first direction from said mounting portion base; and
a seal portion comprising:
a seal portion base;
a bulb seal extending in a first direction from said seal portion base;
a tab extending in a second direction from said seal portion base, said tab selectively engageable with said tab-receiving channel; and
a seal portion latch extending in said second direction from said seal portion base, said seal portion latch selectively engageable with said mounting portion latch.

9. The seal assembly of claim 8 wherein said mounting base defines a second channel between said tab-receiving channel and said mounting base latch.

10. The seal assembly of claim 8, said mounting portion further comprising a second mounting portion base and a web connecting said second mounting portion base to said first mounting portion base.

11. The seal assembly of claim 10, said web comprising an expansion joint.

12. The seal assembly of claim 8, said seal portion further comprising a wiper extending from said bulb seal.

13. The seal assembly of claim 12 wherein said bulb seal is a D-shaped bulb seal.

14. The seal assembly of claim 12 wherein said bulb seal comprises an arcuate portion having a first end connected to said base, a first planar portion having a first end connected to a second end of said arcuate portion, and a second planar portion having a first end connected to a second end of said first planar portion and a second end connected to said base.

15. The seal assembly of claim 8 wherein said bulb seal comprises an arcuate portion having a first end connected to said base, a first planar portion having a first end connected to a second end of said arcuate portion, and a second planar portion having a first end connected to a second end of said first planar portion and a second end connected to said base.

16. The seal assembly of claim 15 wherein said sidewall of said arcuate portion has a region of reduced sidewall thickness intermediate said first end and said second end.

17. The seal assembly of claim 16 wherein said region of recued thickness comprises a scallop extending inwardly into said sidewall an inner surface of said sidewall.

18. The seal assembly of claim 8 wherein said tab and said tab-receiving channel are configured to facilitate insertion of said tab into and removal of said tab from said tab-receiving channel when said tab is in a first orientation with respect to said tab-receiving channel and to resist removal of said tab from said tab-receiving channel when said tab is rotated to a second orientation with respect to said tab-receiving channel.

19. The seal assembly of claim 18 wherein said seal portion latch is configured to engage with said mounting portion latch when said tab is rotated from said first orientation to said second orientation.

20. The seal assembly of claim 18 wherein said tab and said tab-receiving channel are configured to resist sliding of said tab within said tab-receiving channel when said tab is in said second orientation.
